(19) United States
(12) Patent Application Publication
(10) Pub. No.: US 2013/0344382 A1
(43) Pub. Date: Dec. 26, 2013

(54) LI-ION BATTERY POSITIVE PLATE STRUCTURE

(71) Applicants: NingDe Amprerex Technology Limited, Ningde City (CN); Dongguan Amperex Technology Limited, Dongguan (CN)

(72) Inventors: Baiqing Li, Ningde City (CN); Shengwu Zhang, Ningde City (CN); Jirong Li, Ningde City (CN); Zetian Tao, Ningde City (CN); Xuewen Song, Ningde City (CN); Baiqing Zhang, Ningde City (CN)

(21) Appl. No.: 13/906,811

(22) Filed: May 31, 2013

(30) Foreign Application Priority Data
Jun. 20, 2012 (CN) 201210204924.4

(51) Int. Cl. H01M 4/66

(52) U.S. Cl. CPC H01M 4/662
USPC 429/211

(57) ABSTRACT

The invention pertains to the technical field of a Li-ion battery, in particular to a Li-ion battery positive plate structure, comprising a current collector, a base diaphragm arranged on the surface of the current collector and a top diaphragm arranged on the surface of the base diaphragm; both the base diaphragm and the top diaphragm respectively comprise an active substance, an adhesive and a conductive additive, wherein, the active substance of the base diaphragm is graphite, while the active substance of the top diaphragm is at least one among silicon, silicon alloy and tin alloy. Compared with the prior art, the Li-ion battery positive plate structure of the invention successfully solves the problem of film removal of silicon anode and alloy anode due to swelling in the process of charging because a graphite anode base diaphragm with buffering function is installed between the top diaphragm with swelling trend.

### FIELD OF THE INVENTION

The invention pertains to the technical field of a Li-ion battery, in particular to a Li-ion battery positive plate structure.

### BACKGROUND OF THE INVENTION

Since the large-scale commercialization, the Li-ion battery, by virtue of its advantages of high energy density and high power density, is universally used in portable electrical equipment such as laptop computers, video cameras and mobile communication. However, with continuous upgrade of consumer electronics, electronic products have more and more integrated functions. Consequently, people are increasingly demanding for battery energy density.

In order to increase battery energy density, a number of silicon anode and alloy anode materials with high energy density have been gradually developed in recent years. Both the silicon anode material and the alloy anode material have large swelling although they have remarkable effect on increasing battery energy density. Correspondingly, in the process of repeated recharge-discharge, serious film removal may occur on battery cells adopting the silicon anode material or the alloy anode material as the anode active substance. This is because in the process of recharging, the diaphragms made from the silicon anode and alloy anode materials tend to swelling on a flat surface parallel to the current collector; however, in the process of recharging, the current collector with a high intensity is free from lithium intercalation and extension of the current collector is negligible; that is to say, the current collector is hardly swelling. Consequently, a large swelling gradient is generated on the interface between the diaphragm and the current collector. Under the action of the swelling gradient, a great shear stress is eventually generated on the interface between the diaphragm and the current collector, thus causing the diaphragm dropped from the current collector.

As for a traditional single-layer diaphragm structure, on the whole there is no a good method to solve the problem of film removal of silicon anode and alloy anode materials due to swelling in the process of charging. However, in order to solve the problem to a certain degree, bonding strength between the diaphragm and the current collector is enhanced by significantly increasing content of the adhesive in the diaphragm, so as to resist the stress generated on the interface between the diaphragm and the current collector due to swelling of the diaphragm in the process of charging; however, this may reduce the content of the active substance in the diaphragm and dynamics performance of the diaphragm. Of course, the swelling gradient generated between the diaphragm and the current collector can be reduced by decreasing the degree of lithium intercalation of the silicon anode and alloy anode materials. However, this runs counter to the original intention of increasing the energy density by using the silicon anode and alloy anode materials completely.

On that account, it is indeed necessary to provide a Li-ion battery positive plate structure, which can solve the problem of film removal of the silicon anode and alloy anode materials due to swelling in the process of charging under the premise of not affecting performance of battery cells, thus making it possible to increase the energy density by using the silicon anode and alloy anode materials.

### SUMMARY OF THE INVENTION

The aim of the invention is, in view of disadvantages of the prior art, to provide a Li-ion battery positive plate structure, which can solve the problem of film removal of the silicon anode and alloy anode materials due to swelling in the process of charging under the premise of not affecting performance of battery cells, thus making it possible to increase the energy density by using the silicon anode and alloy anode materials, so as to overcome the disadvantages of film removal of the silicon anode and the alloy anode due to swelling in the process of charging of batteries.

In order to achieve the above-mentioned aim, the invention adopts such a technical scheme as below: a Li-ion battery positive plate structure, comprising a current collector, a base diaphragm arranged on the surface of the current collector and a top diaphragm arranged on the surface of the base diaphragm; both the base diaphragm and the top diaphragm respectively comprise an active substance, an adhesive and a conductive additive, wherein, the active substance in the base diaphragm is graphite, while the active substance in the top diaphragm is at least one among silicon, silicon alloy and tin alloy.

The anode diaphragm of the invention is a double-layer structure, wherein the top diaphragm is a silicon anode and/or an alloy anode diaphragm with a trend to swelling on a flat surface parallel to the current collector, and the base diaphragm is a graphite anode diaphragm which serves as a buffer layer. In defect of buffering action of the base diaphragm, the top diaphragm with a trend of swelling is directly cohered to the current collector. In the process of charging, a large swelling gradient and interface stress are generated on the interface between the silicon anode and/or alloy anode diaphragms with a trend to swelling, thus causing the diaphragm dropped from the current collector.

In the invention, a graphite anode base diaphragm which has a buffering action is arranged between the top diaphragm with a trend to swelling and the current collector so that the top diaphragm with a trend of swelling is directly cohered to the base diaphragm with a buffering action instead of directly bonding to the current collector which is directly cohered to the base diaphragm with a buffering action. Also, graphite in the base diaphragm with a buffering action has a trend to swelling of lithium intercalation in the process of charging. Under the circumstances, it can be deemed that the swelling gradient on the interface between the top diaphragm and the base diaphragm is the difference value between swelling trend of the top diaphragm and that of the base diaphragm because the base diaphragm also has a trend to swelling although the top diaphragm has a great trend to swelling. In other words, the swelling trend of the top diaphragm is counteracted somewhat by the base diaphragm or the base diaphragm actually plays a role of a buffer layer.

Of course, the adhesive, the conductive additive or a composite material made up of the adhesive and the conductive additive can be chosen as the buffer layer. However, the buffer layer of invention using the graphite anode diaphragm has the advantage of having a minimum affect on dynamics performance and energy density of battery cells. Graphite itself has high gram volume and initial coulombic efficiency, thus not having an obvious affect on energy density of battery cells. Besides, graphite itself has good electroconductibility, and content of the adhesive in pole pieces is very low, therefore the buffer layer does not affect dynamics performance of battery cells. The main reason of choosing the adhesive as a buffer material is to coordinate swelling trend of the anode diaphragm by means of elastic deformation of the adhesive. However, the ultimate electroconductibility of the adhesive, the conductive additive or the composite material made up of the adhesive and the conductive additive is inferior to that of the graphite anode diaphragm because the adhesive itself has poor electroconductibility even though a composite conductive additive is used for improving the electroconductibility of the adhesive. In addition, the adhesive itself has no gram volume and the conductive additive has low initial coulombic efficiency, thus having a certain affect on energy density of battery cells.

As an improvement of the Li-ion battery positive plate structure in the invention, thickness of the bas diaphragm is less than that of the top diaphragm.

As an improvement of the Li-ion battery positive plate structure in the invention, the bas diaphragm has a thickness of 2-30 μm and the top diaphragm has a thickness of 40-150 μm. Thickness of the bas diaphragm shall be as low as possible in order to guarantee the best performance of battery cells. Compared with the silicon anode or the alloy anode, gram volume of graphite is relatively low. Therefore, thickness of the base diaphragm shall be reduced as much as possible so as to make the minimum loss of energy density. Anyway, thickness of the base diaphragm shall be not too low for the reasons as below: on the one hand, the base diaphragm has no obvious buffering action on swelling of the top diaphragm if it is too thin; on the other hand, graphite granule is too small and graphite activity becomes stronger if the base diaphragm is too thin, which accelerates side reaction of graphite in the electrolyte and adversely affecting battery performance. For the reasons above, the base diaphragm with a thickness of 2-30 μm is optimal.

As an improvement of the Li-ion battery positive plate structure in the invention, the bas diaphragm has a thickness of 5-15 μm and the top diaphragm has a thickness of 50-100 μm.

As an improvement of the Li-ion battery positive plate structure in the invention, the bas diaphragm has a thickness of 10 μm and the top diaphragm has a thickness of 65 μm.

As an improvement of the Li-ion battery positive plate structure in the invention, the swelling ratio of the base diaphragm to the top diaphragm is ⅓-⅔. The better it is if swelling trend of the base diaphragm is more approximate to that of the top diaphragm in order to guarantee the best buffering effect. However, actually, swelling trend of the base diaphragm shall be not too great so as to prevent the problem of film removal of the base diaphragm and the current collector due to swelling in the process of charging. Consequently, the preferred swelling ratio of the base diaphragm to the top diaphragm is ⅓-⅔.

As an improvement of the Li-ion battery positive plate structure in the invention, the silicon alloy is at least one of silicon-carbon alloy and silicon-aluminum alloy.

As an improvement of the Li-ion battery positive plate structure in the invention, the tin alloy is at least one among tin-carbon alloy, tin-copper alloy and tin-cobalt alloy.

As an improvement of the Li-ion battery positive plate structure in the invention, the adhesive is at least one of polyvinylidene fluoride (PVDF) and styrene butadiene rubber (SBR).

As an improvement of the Li-ion battery positive plate structure in the invention, the conductive additive is at least one among superconductive carbon, vapor-phase carbon fiber and a carbon nano tube.

Compared with the prior art, the Li-ion battery positive plate structure of the invention successfully solves the problem of film removal of silicon anode and the alloy anode due to swelling in the process of charging because the graphite anode base diaphragm with buffering function is installed between the top diaphragm with swelling trend and the current collector and consequently the swelling trend of the top diaphragm is counteracted somewhat by the base diaphragm, thus making it possible to increase the energy density by using the silicon anode and alloy anode materials; besides, in the invention the graphite anode diaphragm is chosen as the buffer layer, which has the advantage of having a minimum affect on dynamics performance and energy density of battery cells.

### BRIEF DESCRIPTION OF THE DRAWINGS

Detailed description of the invention and the beneficial technical effect is made in conjunction with the accompanying drawings and embodiments as below.

FIG. 1 is a structure diagram of the invention.

### DETAILED DESCRIPTION OF THE EMBODIMENTS

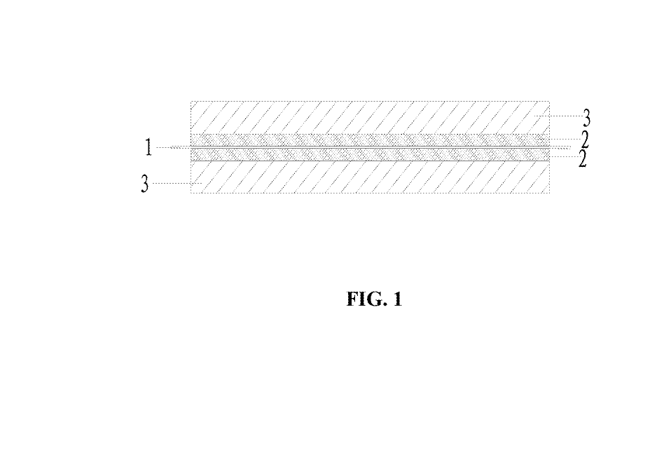

As shown in FIG. 1, the invention relates to a Li-ion battery positive plate structure, comprising a current collector 1, a base diaphragm 2 arranged on the surface of the current collector 1 and a top diaphragm 3 arranged on the surface of the base diaphragm 2; both the base diaphragm 2 and the top diaphragm 3 respectively comprise an active substance, an adhesive and a conductive additive, wherein, the active substance of the base diaphragm 2 is graphite, while the active substance of the top diaphragm 3 is at least one among silicon, silicon alloy and tin alloy.

### Embodiment 1

Preparation of the positive plate: graphite (an anode active substance), superconductive carbon (a conductive additive, hereinafter to be referred as Super-P), sodium carboxymethylcellulose (a thickening agent, hereinafter to be referred as CMC) and styrene butadiene rubber (an adhesive agent, hereinafter to be referred as SBR) are mixed uniformly by a mass ratio of 96: 2: 2: 2 and made into slurry which is coated on the current collector 1 (a copper foil) and baked at a temperature of 85° C. In this way, the base diaphragm 2 with a thickness of 2 μm is made.

Then, silicon (an anode active substance), Super-P, CMC and SBR are mixed uniformly by a mass ratio of 90:2:4:4 and made into slurry which is coated on the base diaphragm 2 and baked at a temperature of 85° C. In this way, the top diaphragm 3 with a thickness of 65 μm is made. And then the top diaphragm is side cut, sliced, stripped and then baked for 4 hours at a temperature of 110° C. under vacuum; then the anode tab is welded. In this way, the positive plate of the Li-ion battery is manufactured.

Preparation of the negative plate: lithium cobaltate (a cathode active substance), Super-P and polyvinylidene fluoride (an adhesive, hereinafter to be referred as PVDF) are mixed uniformly by a mass ratio of 96:2.0:2.0 and made into Li-ion battery cathode slurry with a certain viscosity; the slurry is coated on a current collector (aluminium foil), baked at a temperature of 85° C., cold pressed, side cut, sliced, stripped and then baked again for 4 hours at a temperature of 85° C. under vacuum; then the cathode tab is welded. In this way, the negative plate of the Li-ion battery is manufactured.

A 16 um-thick polypropylene diaphragm is chosen as the diaphragm of the invention.

The negative plate, the positive plate and the diaphragm are wound into a battery cell; the diaphragm is positioned between the negative plate and the positive plate.

Preparation of the electrolyte: a mixed solvent can be made by blending ethylene carbonate (EC), propylene carbonate (PC) and diethyl carbonate (DEC) by a volume ratio of 2:1:2, then fluoroethylene carbonate (FEC) with a mass percentage of 2wt % is put into the mixed solvent, at last lithium hexafluorophosphate (a solute) is put into the mixed solvent until the solute concentration reaches 1M. In this way, the electrolyte can be made.

Preparation of the battery: the battery cell is put into the packing bag, and then the electrolyte is injected into the packing bag; the semi-finished battery is charged to 4.2V by a constant current of 0.1 C (160 mA), then is charged at a constant voltage charge of 4.2V until the current is reduced to 0.05 C (80 mA), then is discharged to 3.0V at a current of 0.1 C (160 mA) (the above charge-discharge is repeated twice) and at last is charged to 3.85V at a current of 0.1 C (160 mA). In this way, the battery is made.

### Embodiment 2

Embodiment 2 is different from Embodiment 1 in that the base diaphragm 2 has a thickness of 5 μm, the active substance in the top diaphragm 3 is silicon-carbon alloy, and the top diaphragm 3 has a thickness of 80 μm.

The remaining steps are the same as described in Embodiment 1, not repeated here.

### Embodiment 3

Embodiment 3 is different from Embodiment 1 in that the base diaphragm 2 has a thickness of 10 μm, the active substance in the top diaphragm 3 is tin-carbon alloy, the top diaphragm 3 has a thickness of 40 μm, and conductive additives of both the base diaphragm 2 and the top diaphragm 3 are vapor-phase carbon fibers.

The remaining steps are the same as described in Embodiment 1, not repeated here.

### Embodiment 4

Embodiment 4 is different from Embodiment 1 in that the base diaphragm 2 has a thickness of 15 μm, the active substance in the top diaphragm 3 is tin-copper alloy, the top diaphragm 3 has a thickness of 100 μm, and conductive additives of both the base diaphragm 2 and the top diaphragm 3 are carbon nano tubes.

The remaining steps are the same as described in Embodiment 1, not repeated here.

### Embodiment 5

Embodiment 5 is different from Embodiment 1 in that the base diaphragm 2 has a thickness of 20 μm, the active substance in the top diaphragm 3 is tin-cobalt alloy, the top diaphragm 3 has a thickness of 120 μm, and adhesives of both the base diaphragm 2 and the top diaphragm 3 are polyvinylidene fluoride (PVDF).

The remaining steps are the same as described in Embodiment 1, not repeated here.

### Embodiment 6

Embodiment 6 is different from Embodiment 1 in that the base diaphragm 2 has a thickness of 25 μm, the active substance in the top diaphragm 3 is silicon-aluminum alloy, and the top diaphragm 3 has a thickness of 150 μm.

The remaining steps are the same as described in Embodiment 1, not repeated here.

### Embodiment 7

Embodiment 7 is different from Embodiment 1 in that the base diaphragm 2 has a thickness of 30 μm, the active substance in the top diaphragm 3 is silicon, the top diaphragm 3 has a thickness of 90 μm, and conductive additives of both the base diaphragm 2 and the top diaphragm 3 are mixture of the carbon nano tube and Super-P by a mass ratio of 1:5.

The remaining steps are the same as described in Embodiment 1, not repeated here.

### Embodiment 8

Embodiment 8 is different from Embodiment 1 in that the base diaphragm 2 has a thickness of 10 μm, the active substance in the top diaphragm 3 is a mixture of silicon-aluminum alloy and silicon-carbon alloy by a mass ratio of 1:3, and the top diaphragm 3 has a thickness of 65 μm.

The remaining steps are the same as described in Embodiment 1, not repeated here.

### Comparison Embodiment 1

Comparison Embodiment 1 is different from Embodiment 1 in preparation of the positive plate: silicon (an anode active substance), Super-P, CMC and SBR are mixed uniformly by a mass ratio of 90:2:4:4 and made into slurry which is coated on the current collector (copper foil), baked at a temperature of 85° C., side cut, sliced, stripped and then baked again for 4 hours at a temperature of 110° C. under vacuum; then the anode tab is welded. In this way, the anode diaphragm with a thickness of 65 μm is manufactured, serving as the Li-ion battery cathode with a single-layer structure of silicon anode.

The remaining steps are the same as described in Embodiment 1, not repeated here.

### Comparison Embodiment 2

Comparison Embodiment 2 is different from Comparison Embodiment 1 in that the anode active material is tin-carbon alloy.

The remaining steps are the same as described in Embodiment 1, not repeated here.

Batteries in Embodiments 1-8 and Comparison Embodiments 1 and 2 are charged at a rate of 0.5 C, swelling ratio of the anode diaphragms on a flat surface (plane direction) parallel to the current collector in the process of charging are calculated, ratio of batteries whose diaphragms fall off in the process of initial charging is made a statistics, and energy density of batteries in the process of initial charging is calculated. The results are shown in Table 1.

A charge-discharge cycle test is made at rate of 0.5 C/0.5 C for batteries, and ratio of batteries whose diaphragms fall off after 100 cycles are made a statistics. The results are shown in Table 1.

TABLE 1
diaphragm removal and energy density of batteries in
Embodiments 1-8 and Comparison Embodiments 1 and 2

| | Swelling ratio of anode diaphragms on | | Ratio of | Energy density | Ratio of batteries |
|---|---|---|---|---|---|
| | a flat surface in the process of charging | | batteries whose | of batteries in | whose diaphragms |
| | Top | Base | diaphragms | the process of | fall off after 100 |
| Group | diaphragm 3 | diaphragm 2 | fall off | initial charging | cycles |
| Embodiment 1 | 7% | 4.7% | 0% | 539 Wh/L | 5% |
| Embodiment 2 | 7% | 2.3% | 0% | 537 Wh/L | 4% |
| Embodiment 3 | 7% | 3.5% | 0% | 540 Wh/L | 0% |
| Embodiment 4 | 7% | 3.5% | 0% | 536 Wh/L | 0% |
| Embodiment 5 | 8% | 4.0% | 0% | 534 Wh/L | 0% |
| Embodiment 6 | 7% | 3% | 0% | 532 Wh/L | 2% |
| Embodiment 7 | 7% | 3.5% | 0% | 530 Wh/L | 0% |
| Embodiment 8 | 7% | 3.5% | 0% | 537 Wh/L | 0% |
| Comparison | 7% | / | 20% | 540 Wh/L | 50% |
| Embodiment 1 | | | | | |
| Comparison | 7% | / | 25% | 542 Wh/L | 57% |
| Embodiment 2 | | | | | |

From Table 1 we can see that: in Embodiment 1, after the initial charging, ratio of batteries whose diaphragms fall off is 0%; after 100 cycles, ratio of batteries whose diaphragms fall off is 5%, which is mainly resulted from separation of the base diaphragm 2 from the top diaphragm 3. This shows that the relative swelling capacity between the base diaphragm 2 and the current collector 1 is too high. In Comparison Embodiment 1, after the initial charging, ratio of batteries whose diaphragms fall off is 20%; after 100 cycles, ratio of batteries whose diaphragms fall off 1 is as high as 50%. Consequently, compared with Comparison Embodiment 1, improvement effect of batteries in Embodiment 1 is quite obvious. Meanwhile, energy density of batteries in Embodiment 1 in the initial charging is measured 539 Wh/L, while energy density of batteries in Comparison Embodiment 1 in the initial charging is measured 540 Wh/L, which shows that 2 m-thick base diaphragm 2 has little affect on energy density of batteries. Similarly, the above-mentioned conclusion can be also obtained by making a comparison between Embodiment 3 and Embodiment 2.

In Embodiment 2, after 100 cycles, ratio of batteries whose diaphragms fall off is 4%, which is mainly resulted from separation of the base diaphragm 2 from the top diaphragm 3. This shows that the relative swelling capacity between the base diaphragm 2 and the current collector 1 is too high and the buffering action is limited.

In Embodiment 3, after 100 cycles, ratio of batteries whose diaphragms fall off is 0%, which shows that the base diaphragm 2 which has a moderate swelling ration not only has an obvious buffering effect on swelling of the top diaphragm 3 but also guarantees a firm adhesion between the base diaphragm 2 itself and the current collector 1.

In Embodiment 7, the base diaphragm 2 of the anode diaphragm has a thickness of 30 μm, after the initial charging, ratio of batteries whose diaphragms fall off is 0%; after 100 cycles, ratio of batteries whose diaphragms fall off is also 0%, which shows a striking improvement effect. However, energy density of the batteries in Embodiment 7 in the initial charging is measured 530 Wh/L, which shows 30 m-thick base diaphragm 2 has an obvious affect on energy density of batteries.

Those skilled in the art can, on the basis of disclosure and instruction of the specification above-mentioned, make a change or modification of the embodiments mentioned above. Therefore, the invention is not limited to the embodiments, and equivalent modification and change of the invention are within the scope of protection of claims of the invention. In addition, some specific terms are used in the specification for the convenience of description, but not to limit the invention.

What is claimed is:

1. A Li-ion battery positive plate structure, comprising a current collector, a base diaphragm arranged on the surface of the current collector and a top diaphragm arranged on the surface of the base diaphragm; both the base diaphragm and the top diaphragm respectively comprise an active substance, an adhesive and a conductive additive, wherein, the active substance of the base diaphragm is graphite, while the active substance of the top diaphragm is at least one among silicon, silicon alloy and tin alloy.

2. The Li-ion battery positive plate structure of claim 1, wherein thickness of the base diaphragm is less than that of the top diaphragm.

3. The Li-ion battery positive plate structure of claim 2, wherein thickness of the base diaphragm is 2-30 μm while thickness of the top diaphragm is 40-150 μm.

4. The Li-ion battery positive plate structure of claim 3, wherein thickness of the base diaphragm is 5-15 μm while thickness of the top diaphragm is 50-100 μm.

5. The Li-ion battery positive plate structure of claim 4, wherein thickness of the base diaphragm is 10 μm while thickness of the top diaphragm is 65 μm.

6. The Li-ion battery positive plate structure of claim 1, wherein the swelling ratio of the base diaphragm to the top diaphragm is ⅓-⅔.

7. The Li-ion battery positive plate structure of claim 1, wherein the silicon alloy is at least one of silicon-carbon alloy and silicon-aluminum alloy.

8. The Li-ion battery positive plate structure of claim 1, wherein the tin alloy is at least one among tin-carbon alloy, tin-copper alloy and tin-cobalt alloy.

9. The Li-ion battery positive plate structure of claim 1, wherein the adhesive is at least one of polyvinylidene fluoride (PVDF) and styrene butadiene rubber (SBR).

10. The Li-ion battery positive plate structure of claim 1, wherein the conductive additive is at least one among superconductive carbon, vapor-phase carbon fiber and a carbon nano tube.
